(19) United States
(12) Patent Application Publication
(10) Pub. No.: US 2020/0039091 A1
(43) Pub. Date: Feb. 6, 2020

(54) ROBOTIC STRUCTURE WITH SIX DEGREES OF FREEDOM ALLOWING GRIPPING

(71) Applicant: UNIVERSITÉ DE FRANCHE-COMTÉ, Besançon (FR)

(72) Inventors: Redwan DAHMOUCHE, Besançon (FR); Wissem HAOUAS, Besançon (FR)

(73) Assignee: Université de Franche-Comté, Besançon (FR)

(21) Appl. No.: 16/339,113

(22) PCT Filed: Sep. 29, 2017
(86) PCT No.: PCT/FR2017/052665

§ 371 Date: Apr. 3, 2019

(30) Foreign Application Priority Data
Oct. 6, 2016 (FR) 1659644

(51) Int. Cl. B25J 15/02; B25J 7/00; B25J 9/00; B25J 9/10; B25J 19/02

(52) U.S. Cl. CPC B25J 15/022; B25J 7/00; B25J 19/02; B25J 9/10; B25J 9/003

(57) ABSTRACT

Some embodiments are directed to a parallel robotic structure with six degrees of freedom, comprising movable bases that can be rotated or translated. A platform coupled with the movable bases by moving elements, wherein the platform is made up of two rigid elements connected to one another by a single articulation. This parallel robotic structure makes it possible to perform cutting, gripping and manipulating operations simultaneously with six degrees of without requiring an additional tool. The gripping functionality is provided due to the articulated platform, which is an integral part of the mechanical architecture and can be entirely controlled by the offset actuators located in the stationary base.

### CROSS REFERENCE TO RELATED APPLICATIONS

This application is a national phase filing under 35 C.F.R. § 371 of and claims priority to PCT Patent Application No. PCT/FR2017/052665, filed on Sep. 29, 2017, which claims the priority benefit under 35 U.S.C. § 119 of French Patent Application No. 1659644, filed on Oct. 6, 2016, the contents of each of which are hereby incorporated in their entireties by reference.

### BACKGROUND

Some embodiments of the presently disclosed subject matter are directed to a parallel robotic structure with at least six degrees of freedom allowing gripping and manipulating in particular for micro-nano-manipulation.

From a structural standpoint, industrial manipulator robots can be classed into two categories: serial robots and parallel robots. Serial robots, referred to as manipulator arms, are the most widespread in industry and are characterised by an open kinematic chain (a series of actuators, connections and arms) which ranges from the base of the robot to the wrist. Parallel robots are characterised by several parallel kinematic chains connected from the base to the platform.

The advantage of parallel robots in relation to serial robots is that they have greater rigidity and the possibility of fixing the actuators on the base of the robot which makes it possible to lighten the portions in movement. The consequence is that the masses that can be transported by the robot are more substantial and the accelerations are stronger. The favoured applications are applications for rapid taking and moving as described in patent WO 87/03 528 or the moving of heavy loads such as cockpits in flight simulators as described in U.S. Pat. No. 3,295,224.

In most parallel robots, the platform is made up of a rigid body. However, a few particular robots have an articulated platform. U.S. Pat. No. 6,516,681 describes a robot of this type that has four degrees of freedom at most of which three in translation and one in rotation. The rotation of the tool is obtained thanks to the reconfiguration of a platform made up of three elements articulated by pivoting links. A similar robot limited to the same degrees of freedom but having a parallelogram as a platform is described in patent EP 1 870 214. Note that the robots described in the patents mentioned hereinabove were a great success and have been widely commercialised.

### SUMMARY

According to some embodiments, the operations carried out by the robots may require the use of suitable electrical, hydraulic or pneumatic tools (clamps, etc.) attached to the wrists of serial robots or on the platforms of parallel robots (including the robots mentioned hereinabove). Although this configuration is adequate in a certain number of applications, it has limitations in particular in the applications that have high constraints in terms of size, a need for miniaturisation and/or to lighten as much as possible the masses displaced.

In some embodiments, functions such as gripping, manipulation in the six degrees of freedom of space and cutting for example are provided by a parallel robotic mechanism without the adding of additional actuated tools, and this thanks to an articulated platform. Thus, the robotic structure according to some embodiments make it possible on the one hand to overcome the electrical, pneumatic or hydraulic connections used for the actuation of any tools and on the other hand to reduce the size and the mass on the platform of the robot which facilitates the miniaturisation thereof. In addition, the structure of the robot makes it possible to place the actuators far from the platform, in particular by using cables, thus making the structure even more compact.

The applications have high constraints in terms of size such as mini-invasive surgery in the biomedical field where the robot is inserted into the human body through a tube or an endoscope. Moreover, the capacity for miniaturisation of the robotic structure according to some embodiments (the structure able to be manufactured on a micrometric scale) make it particularly suitable for high-precision and high-speed manipulation in particular for millimetric components (timepiece components, electronic components, etc.), micrometric components (Micro-ElectroMacatronic Systems, MOEMS, etc.) and even nanometric components (nanowires, nanotubes, etc.) are thus able to exceed the manipulation precision and production speeds of the existing systems. Finally, the robot, which is characterised by six degrees of freedom in translation and in rotation in addition to the configurable platform which provides it with additional degrees of freedom, makes it one of the most versatile and most dextrous robots that exist to date, in particular for manipulating components with sizes of a very small dimensions. Accordingly, some embodiments propose a novel robotic structure that simultaneously makes possible gripping and manipulation with six degrees of freedom and cutting for example without the use of a gripper or of an additional actuated tool.

The parallel robotic structure with six degrees of freedom according to some embodiments includes movable bases that can be rotated or translated and a platform coupled with the movable bases by moving elements it is characterised in that the platform is made up of two rigid elements connected to one another by a single link. This novel solution is an original and innovative parallel robotic structure which makes it possible to perform cutting, gripping and manipulating operations simultaneously with six degrees of freedom without needing an additional actuated tool. The gripping functionality is provided thanks to the articulated platform which itself is an integral part of the mechanical architecture and can be entirely controlled by the offset actuators located in the stationary base.

This structure allows for positioning according to the six degrees of freedom in the space of a platform included of two movable rigid elements. These two movable rigid elements are connected together in such a way as to be able to pivot and/or translate one of the movable elements in relation to the other about or along one or several axes that can be used for the carrying out of various tasks (gripping, manipulating, cutting, etc.) thanks to a single link. The two movable elements of the platform are connected to several, for example seven, third spacers rigidly. Each third spacer is connected at its other end to a second spacer rigidly or by a ball joint, a pivot or a universal joint. Each second spacer is connected at its other end to a first spacer rigidly or by a ball joint, a pivot or a universal joint. Each first spacer is connected to a movable base and can translate along or pivot about at least an axis. The setting into movement of the first spacers can be carries out by one or several actuators linked to the movable bases rigidly or through passive connections and/or flexible connections and/or cables. The fixed portion of the actuators are connected to the base element by a rigid or passive or flexible connection. The whole is arranged in such a way that the positions and the orientations of the movable elements of the platform in the space as well as the distance and/or the angle between the two movable elements can be controlled by the movements of the actuators controlled by a management computer. The degrees of freedom beyond 6 are used so as to carry out particular tasks such as gripping, cutting, etc. If the number of arms is greater than seven this makes it possible to obtain more degrees of freedom on the platform and/or actuating redundancies and/or additional measurements. On the other hand, a redundant device in terms of actuation makes it possible to increase the working area, limit the presence of kinematic singularities, control the internal constraints in the kinematic chain of the device, increase the forces and torques transmitted to the movable elements as well as the speeds and accelerations thereof.

Advantageously, the link is a pivoting link.

Advantageously, the movable bases are arranged symmetrically. A symmetrical robot makes it possible to homogenise the dimensions of the parts, simplify the design, the modelling, the manufacture and the control of the device.

According to an arrangement of some embodiments, the moving elements of the spacers linked by passive articulations on the one hand to the articulated platform and on the other hand to a movable base are linear actuators. The fixed portions of the actuators are, for example, rigidly connected to a base element which makes it possible to lighten the movable portions of the device. This is passed on to the movable elements via a gain in speed, acceleration and in force that can be applied (makes it possible in particular to transport substantial loads). The passive links can be replaced with flexible connections which makes it possible to manufacture the device on a miniaturised scale (millimetric, micrometric). Indeed, this makes it possible to eliminate the clearances that can exist in conventional connections (pivot, ball joint, cardan, etc.) and which are a source of degradation in performance (repeatability, precision, etc.).

Advantageously, the passive articulations are ball joints, pivots or universal joints. The translations and the rotations of the movable elements can be obtained solely from translations of actuators which allows for a gain in compactness and precision. The actuators can be offset far from the movable elements (by f cables or bars for example) in order to obtain very compact systems that are useful in applications with a high size constraint (medical, nuclear, aerospace, etc.).

Advantageously, the structure includes force sensors arranged on the movable bases. This makes it possible to self-calibrate the robot whereon the structure is mounted, to simplify the calculation of the positions and orientations of the movable elements and to improve the precision of the movements thereof. The forces are transmitted from the actuators to the movable elements which makes it possible to measure and/or control the forces and the torques applied by the movable elements on the environment thereof.

Advantageously, the structure includes position sensors arranged on the actuators.

Advantageously the structure is of sub-millimetric size. The structure can thus be used for micro-nano-manipulation and micro-nano-assembly as well as manipulation in confined areas (endoscopes, mini-invasive surgeries). The structure can be manufactured on a macrometric scale (greater than the sizes of conventional robots), miniaturised scale (endoscopy for example) or micrometric scale (micro-nanomanipulation for example). The millimetric structure can be made up of micrometric elements, it could also be of centimetric size or even larger and carry out micro-nano manipulation tasks. It can for example be applied to:
the assembly of nano-sensors, optical fibres, semi-conductors,
the testing, controlling and characterisation of micro-nano-objects,
the accurate assembly of optical systems such as interferometers,
the manipulation of biological cells,
the assembly in timepiece industries,
mini-invasive surgery (endoscope instrumented with a clamp with 6 degrees of freedom).

Advantageously, the structure is actuated by actuators in translation (linear motors, electrical or hydraulic cylinders, etc.), in rotation (electric motors, etc.) or less common actuators (piezo-electric, electrostatic, thermal, etc.) that may also have several degrees of freedom (tables XY, piezotubes, etc.).

Compared to the existing robotic structures, the presently disclosed subject matter has the following characteristics:
The gripping or cutting functionality is integrated into the structure and the actuating is carried out from actuators placed on the base element.
The masses and the inertias of the structure on a micrometric scale are very low which allows for cycle times that are much shorter than with current systems.
The precision can be greater than a micrometer (the limit of the current parallel structures) and even down to the nanometric scale.
The cost of manufacturing the system is much less than that of existing systems.
It is possible to perform micro-nano-manipulations and assemblies with six degrees of freedom and operations inside confined areas (human body, scanning electron microscope, etc.).
The passive articulations can be replaced with flexible connections that guarantee high repeatability of the structure and/or biocompatibility.
With the integration of force sensors on the movable bases the forces applied on the terminal member can be measured without using connections (wires, hose, etc.) on the platform.
With the integration of position sensors on the various actuators a self-calibration of the robot can be carried out.
The absence of electrical connectors on the operational portions of the structure allows for the manipulation in constrained environments where the use of electronic components is limited/prohibited (liquids, human body, etc.).
In summary, the system can be more precise, faster and less expensive than the existing solutions.

The solution may require very small quantities of material and can be mass produced with high value added. The system is manufactured using standard methods and does not require the use of any dangerous substance.

Other advantages can again appear to those of ordinary skill in the art when reading the examples hereinbelow, shown in the accompanying figure, given as an example:

### BRIEF DESCRIPTION OF THE FIGURES

FIG. 1 is a graph of the layout of a first structure,

FIG. 2 shows a layout graph of a second structure,

FIG. 3 is an exemplary illustration of the first robotic structure of FIG. 1,

FIG. 4 is an exemplary illustration of the second robotic structure of FIG. 2,

FIG. 5 is another exemplary illustration of a structure with four spacers per arm,

FIG. 6 is exemplary illustration of a structure with one spacer with several branches,

FIG. 7 is an alternative of FIG. 2 where the actuators are arranged between two links.

### DETAILED DESCRIPTION OF THE EXEMPLARY EMBODIMENTS

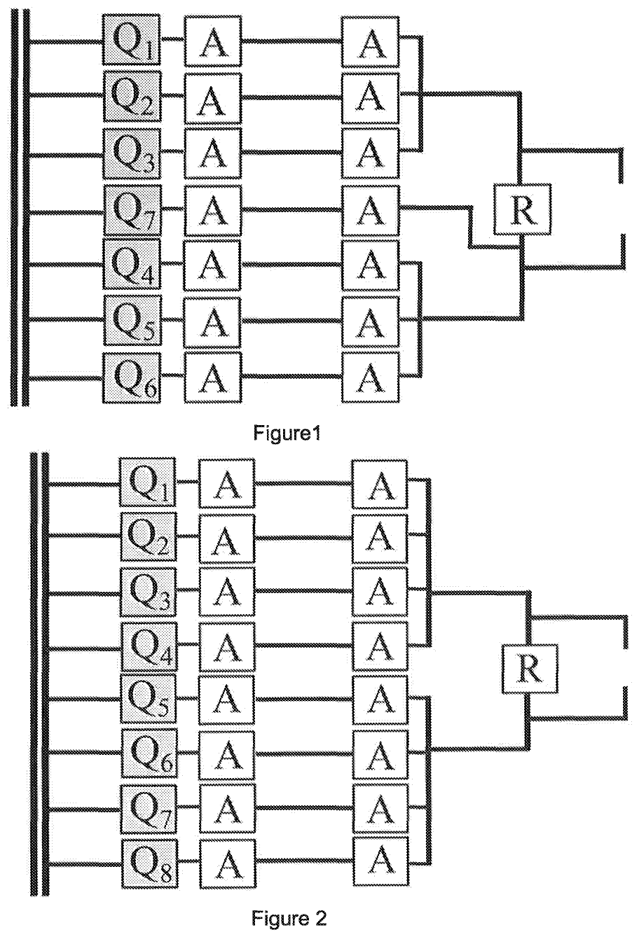

FIGS. 1 and 2 show layout graphs of two different robotic structures. These graphs reveal the topology of the structure of the robots and the various kinematic branches and loops. The conventions used for these graphs are:
A: Liaison passive of the Universal (cardan) or spherical (ball joint) type.
R: Passive link of the Rotational (pivot) type
Qi: Actuator with 1 degree of freedom.

These examples of structures are part of the family of manipulators with six degrees of freedom and more of which certain alternatives are redundant in terms of actuation.

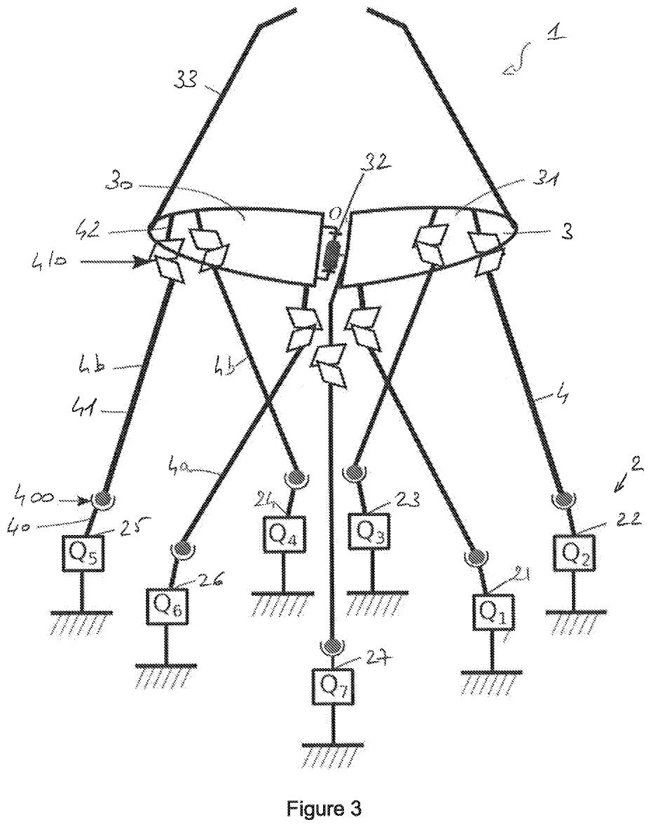

The exemplary illustration shown in FIG. 3 shows a robotic structure 1 with seven movable bases 2, an articulated platform 3 in two portions 30 and 31 connected by a passive connection 32. Each one of the two portions 30 and 31 is extended by a gripper 33; this gripper can be replaced with scissors, clamps or others. Three movable bases 21, 22, 23 are connected to the portion 31 of the articulated platform 3 by an arm 4 and, in the same way, three bases 24, 25, 26 are connected to the portion 32 of the articulated platform 3 by an arm 4.

Each one of the arms 4 is included of three spacers 40, 41 and 42, the first spacer 40 is connected to the second spacer 41 by a passive link 400, the second spacer 41 is connected to the third spacer 42 by a passive link 410. The passive link 400 can be of the spherical type and the connection 410 of the universal type.

Qi actuators are arranged on the spacers 40.

The movements of the portions 30 and 31 of the articulated platform 3 as well as the relative movement between the two portions of the platform are controlled by the movements of the various arms 4. The opening and/or the closing of the grippers 33 is obtained by the displacement of the arms as well as their position and their orientation.

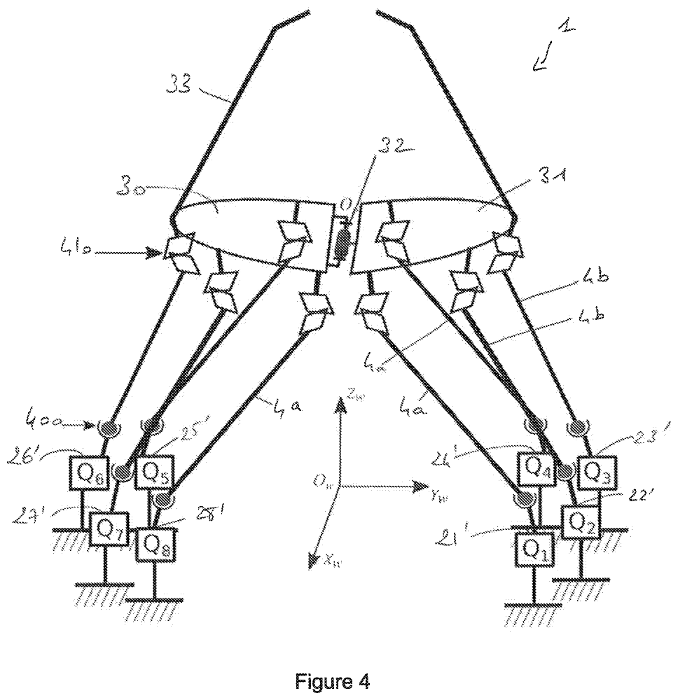

The exemplary illustration shown in FIG. 4 shows a robotic structure 1 that is substantially identical to the preceding one except that it includes eight movable bases 2 instead of seven which makes for a robot that is redundant in actuation.

Here four bases 21′, 22′, 23, 24′ are connected to the portion 31 of the articulated platform 3 by an arm 4 and, in the same way, four bases 25′, 26′, 27, 28′ are connected to the portion 32 of the articulated platform 3 by an arm 4.

Each one of the arms 4 is formed of three spacers 40, 41 and 42, the first spacer 40 is connected to the second spacer 41 by a passive connection 400, the second spacer 41 is connected to the third spacer 42 by a passive connection 410. The passive connection 400 can be of the spherical type and the connection 410 of the universal type.

Qi actuators are arranged on the spacers 40.

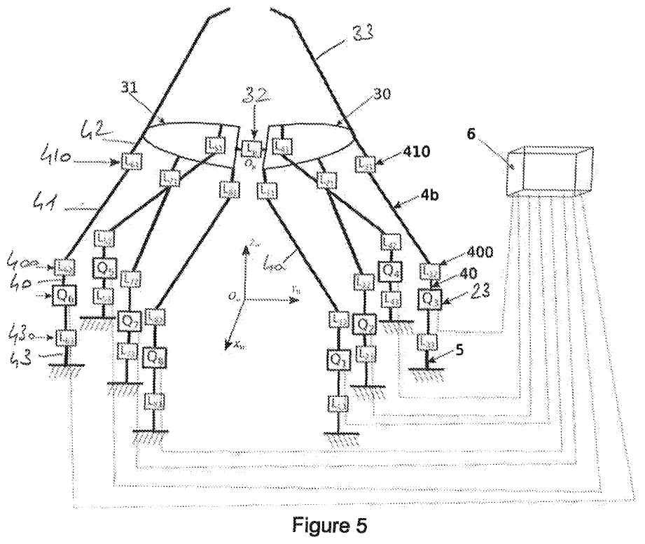

The movements of the portions 30 and 31 of the articulated platform 3 as well as the relative movement between the two portions of the platform are controlled by the movements of the various arms 4. In the example shown in FIG. 5, each arm 4 is included of four spacers 40, 41, 42, 43 connected by three articulations 400, 410, 430. The actuators are controlled by a control 6. This structure makes it possible to use connections that are simpler to carry out therefore less expensive which still being more precise and offering a greater range of displacement.

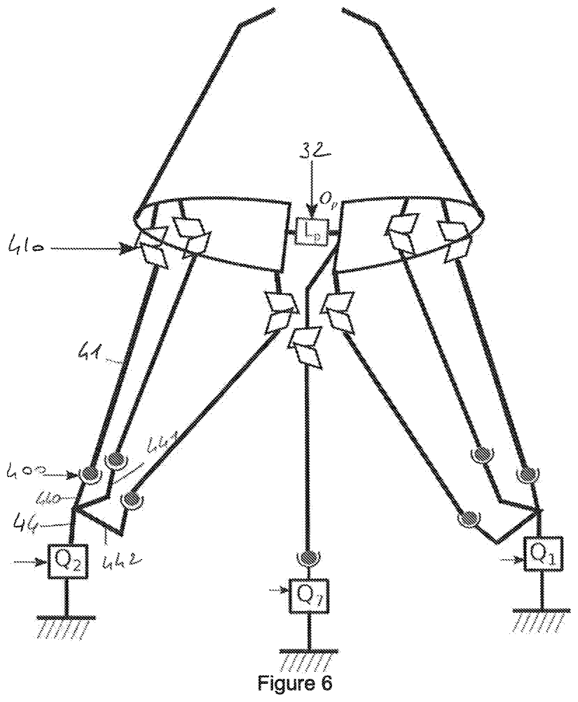

FIG. 6 shows a structure where the arms 4 include a spacer 44 with several branches 440, 441, 442. Here the spacer 44 has three branches but it could have two or more of them. This structure is simpler because it uses fewer actuators, here two actuators with three degrees of freedom at least Q1, Q2 and an actuator with at least one degree of freedom Q7.

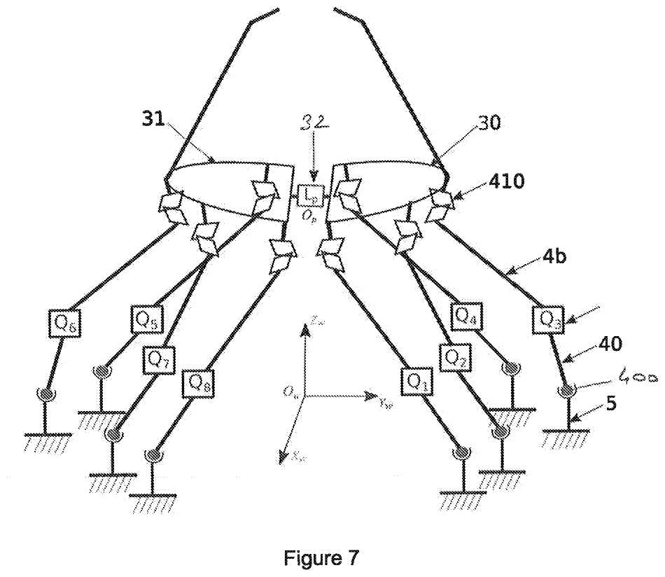

In the alternative of FIG. 7, the actuators Qi are arranged between the two passive links 400 and 410.

1. A parallel robotic structure with six degrees of freedom, comprising:
movable bases that can be rotated or translated; and
a platform coupled with the movable bases by an arm made up of spacers and by moving elements of the spacers, wherein, the platform is made up of two rigid elements connected to one another by a single link.

2. The structure according to claim 1, wherein the link is a pivoting link.

3. The structure according to claim 1, wherein the movable bases are arranged symmetrically.

4. The structure according to claim 1, wherein the moving elements of the spacers are linked by passive articulations to the articulated platform and to a movable base configured as linear actuators.

5. The structure according to claim 1, wherein the passive articulations are ball joints or universal joints.

6. The structure according to claim 1, wherein force sensors are arranged on the movable bases.

7. The structure according to claim 1, wherein the structure is a sub-millimetric size.

8. The structure according to claim 1, wherein the structure is actuated by piezoelectric Qi actuators.

9. The structure according to claim 1, wherein position sensors are arranged on the actuators.
